(19) United States
(12) Patent Application Publication
(10) Pub. No.: US 2003/0224812 A1
(43) Pub. Date: Dec. 4, 2003

(54) Wireless communication management apparatus

(75) Inventors: Kazuhito Gassho, Nagano-ken (JP); Susumu Shiohara, Nagano-ken (JP); Teruhito Kojima, Nagano-ken (JP)

Correspondence Address: SUGHRUE MION, PLLC, 2100 Pennsylvania Avenue, NW, Washington, DC, 20037-3213, US

(73) Assignee: SEIKO EPSON CORPORATION

(21) Appl. No.: 10/405,035

(22) Filed: Apr. 2, 2003

(30) Foreign Application Priority Data
Apr. 4, 2002 (JP) 2002-102576(P)

(51) Int. Cl. H04B 7/00

(52) U.S. Cl. 455/509; 455/514

(57) ABSTRACT

A wireless communication management apparatus of the present invention functions to prevent the decline of the speed of the communication in wireless communication from lowering. A communication channel management apparatus 10 integrally manages a plurality of communication channels in a wireless network to which a diversity of devices are connected. In the communication channel management apparatus 10, a control unit 11 and a wireless relay devices 12 and 13 are united together. In case that a wireless communication device ST2 performs printing with a printer PRT, which is assigned a different communication channel from the current one, a control unit 11 acquires an IP address of the printer PRT through the wireless relay device 12 as information of a communicating destination for the wireless communication device ST2. The control unit 11 previously stores assigning conditions for assigning communication channels into a storage module 102. A channel direction module 103 instructs to switchover the communication channel of the wireless communication device ST2 to channel equivalent of that of the printer PRT.

### BACKGROUND OF THE INVENTION

1. Field of the Invention

The present invention relates to a method of assigning communication channels in wireless communication.

2. Description of the Related Art

Recently, wireless LANs (Local Area Networks) to which a diversity of computers and peripheral devices such as printers are connected with radio waves have become widely used. Each device connecting to a wireless LAN performs wireless communication via a predetermined communication channel. For example, fourteen channels are available for wireless communication that is performed based on the International Standard; IEEE802.11.

The increased number of devices per communication channel, on the other hand, may cause lowering the speed of the communication as the traffic increases. In some communication channels, the speed of the communication is lowered by the deterioration of the radio waves status.

It is possible to change settings of communication channel to the channel which is not crowded with too many devices or where the radio waves status is fine. It is, however, rather hard to change settings in a wireless LAN with a number of devices connected. Furthermore, the traffic may eventually remain high if a number of devices change their settings to the same communication channel.

The increased traffic and the deteriorated radio waves status may cause various troubles, such as bit errors as well as the decline of the speed of the communication.

The above problem is not restricted to wireless LANs, but is commonly found in various types of wireless communication. The object of the present invention is thus to prevent troubles in the wireless communication.

In order to attain at least part of the above and the other related objects, the present invention is directed to a communication channel management apparatus that manages plural communication channels used for wireless communication between wireless communication devices. The first embodiment of the present invention includes a storage module, an information acquisition module and a channel direction module.

The storage module prestores an assigning condition for assigning one of the plural communication channels to be managed. The assigning conditions are, for example, defined so as to give relations between determination factors, such as the content of the communication and communication status and the communication channel to be used.

The information acquisition module acquires predetermined information to be used for judging the assigning conditions. Various kinds of information, such as the IP address of the receiver and the traffic status of the communication channel, may be available for the judgment, both in a combined or an individual form.

The channel direction module instructs the communication channel appropriate for the wireless communication device, based on the information acquired by the information acquisition module and the information stored into the storage module. The instruction may be provided regardless of whether or not the communication channel to be assigned is identical to the current one in use. On the other hand, no instruction may be provided if not required.

In the first embodiment of the present invention, plural communication channels may be managed integrally. This arrangement enables efficient allocation of communication channels, thereby enhancing communication stability with the wireless communication.

In the first embodiment of the present invention, the assigning conditions may be set based on at least one of the speed of the communication, the communication protocol, the volume of file data, file type, the number of the wireless communication devices and the address of the receiver to communicate with. One example of the settings is to assign the different communication channel from the current channel in use when the acquired speed of the communication becomes lower than the predetermined threshold value.

In the first embodiment of the present invention, it is preferable that the predetermined information is acquired via a radio relay device. The determined information preferably includes at least the information used for judging assigning conditions, and is also preferably part of the information acquired in the course of the communication with the wireless communication device. With this arrangement, the volume of the predetermined information is less than the information transmitted from the wireless communication device, thereby enabling lower communication traffic through the communication channel management apparatus and the wireless relay device.

In one application of the first embodiment, the channel direction module may search among communication channels and assign the available channel in response to the request for channel assignment, received from an access point. The search may be performed based on the prescribed search rules, which are stored in the storage module, for selecting the communication channel suitable for the assigning condition, or may be performed in any order among the communication channels that are managed by the communication channel management apparatus. This arrangement may set a newly assigned channel while avoiding already-congested communication channels, thereby actualizing effective allocation of the communication channels.

In the first embodiment of the present invention, in the case that the communication is performed between a sending wireless communication device and a receiving wireless communication device, the channel direction module may instruct both the sending wireless communication device and the receiving wireless communication device to switchover respective communication channels. For example, when both wireless communication devices use different channels from each other, the channel direction module may instruct both devices to switchover respective channels to the channel different from both channels in use. It may be also applicable to instruct both devices to switchover the current channel to the different one when both devices share the channel. This arrangement may avoid the congestion of the communication on each communication channel.

In the first embodiment of the present invention, the channel direction module may further instruct to assign identification information for identifying groups that perform the wireless communication. As an example, “ESS-ID” is utilized as identification information, which is common in the wireless communication based on IEEE802.11. In the present invention, the identification information is assigned as well as the communication channel, thereby enabling the wireless communication even by joining other groups.

The present invention is further directed to a wireless relay device that relays the wireless communication between wireless communication devices on the predetermined communication channel. As a second embodiment of the present invention, the wireless relay device includes an information acquisition module, an information output module and a direction transfer module.

The information acquisition module acquires the predetermined information that is used by the communication channel management apparatus corresponding to the wireless relay device uses for assigning one of the plural communication channels to be managed. It is preferable that the predetermined information is equivalent of that of the first embodiment of the present invention.

The information output module outputs the predetermined information to the communication channel management apparatus. The predetermined information may be output in response to the request for transmission that is received from the wireless communication device, or may be output at the prescribed intervals. Furthermore, the predetermined information may be output in response to the request for transmission that is received from the wireless communication device while being output at the prescribed intervals.

The direction transfer module inputs an instruction as to the communication channel to be used for the wireless communication, and transfers the instruction to the corresponding wireless communication device. The instruction of the communication channel to be used is not restricted to the communication channel, but may also include other information such as the identification information.

According to the second embodiment of the present invention, the wireless relay device may output the information about the communication traffic and the destination of the communication that is received from the wireless communication device, which is relayed by the wireless relay device, to the communication channel management apparatus, and transfer the instruction of the communication channel to be used by the wireless communication device. This arrangement enables the communication channel management apparatus to specify the communication channel suitable for various conditions such as the content of the information transmitted by the wireless communication device and wireless communication status at any time, thereby enhancing efficiency in the process of using communication channel.

In the second embodiment of the present invention, the information output module may output additional information, such as information regarding wireless communication devices newly connected to the wireless communication relayed by the wireless relay device and the number of the wireless communication devices connecting to the wireless relay device, besides the communication traffic observed by the wireless relay device, the content of communication acquired from the wireless communication device and the receiving device to communicate with. This arrangement enables the communication channel apparatus to handle the information involved with the communication channels to be managed integrally, thereby ensuring the flexible instructions for assigning communication channels.

The first embodiment and the second embodiment of the present invention may be constructed as an integrated communication channel management apparatus. For example, the wireless relay device may be integrated with the communication channel management apparatus.

The technique of the present invention is not restricted to the applications of the communication channel management apparatus discussed above, but may be actualized by a diversity of other applications, for example, a method of controlling switchover of a communication channel of a wireless communication device. Other applications also include a computer program that attains the method of controlling switchover of a communication channel of a wireless communication device, a recording medium in which such a computer program is recorded, and a data signal that includes such a computer program and is embodied in a carrier wave. In each embodiment, various features described above are applicable.

When this invention is configured as a computer program or a recording medium which records the computer program, the computer program may include program codes corresponding to whole function of the communication channel management apparatus or only part of those functions. Typical examples of the recording media include flexible disks, CD-ROMs, DVD-ROMs, magneto-optic discs, IC cards, ROM cartridges, punched cards, prints with barcodes or other codes printed thereon, internal storage devices (memories like a RAM and a ROM) and external storage devices of the computer, and a variety of other computer readable media.

The above and other objects, features, aspects, and advantages of the present invention will become more apparent from the following detailed description of the preferred embodiments with the accompanying drawings.

### BRIEF DESCRIPTION OF THE DRAWINGS

FIG. 1 schematically illustrates the configuration of a wireless network in a first embodiment of the present invention;

FIG. 2 schematically illustrates the structure of a control unit 11 in an embodiment of the present invention;

FIG. 3 schematically illustrates the structure of a wireless relay device 12 in an embodiment of the present invention;

FIG. 4 is a flowchart showing communication channel assigning processing in an embodiment of the present invention; and

FIG. 5 is a flowchart showing communication channel switchover processing in a second embodiment of the present invention.

### DESCRIPTION OF THE PREFERRED EMBODIMENT

Some modes of performing the present invention are discussed below as preferred embodiments in the following sequence:

A. First Embodiment:

A1. Outline of System:

A2. General Construction of Control Unit:

A3. General Construction of Wireless Relay Device:

A4. Communication Channel Setting Instruction:

B. Second Embodiment:

B1. Communication Channel Setting Instruction:

C. Modifications:

A. First Embodiment:

A1. Outline of System:

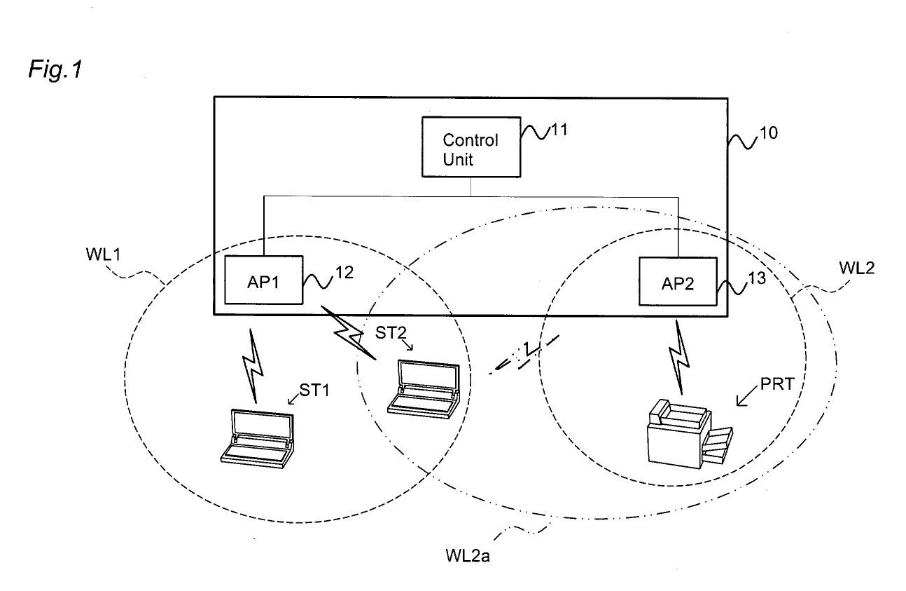

FIG. 1 schematically illustrates the configuration of a wireless LAN in a first embodiment of the present invention, which is constructed based on IEEE802.11. In this embodiment, a communication channel management apparatus 10 includes control unit 11 and internal access points AP1 and AP2. A wireless LAN (WL1) is constructed by the access point AP1 and plural wireless communication devices ST1˜ST2. A wireless LAN (WL2) is constructed by the access point AP2 and a printer PRT. Both the access points AP1 and AP2 function to relay wireless communication and communicate with the control unit 11. Hereafter, the access points AP1 and AP2 are called as a wireless relay device 12 and a wireless relay device 13, respectively.

The range of LANs WL1 and WL2 are partly overlapped each other. The respective communication channels used in WL1 and WL2 are in the range of the frequency free from interference from each other. In this embodiment, communication channel “4CH” is set to the device in the WL1 and “7CH” is set to the device in the WL2 as initial status, respectively.

In one application of this embodiment, the wireless communication device ST2 performs printing with the printer PRT using the different communication channel. To actualize the above application, both devices are required to share the communication channel. In this embodiment, the communication channel management apparatus 10 changes settings of the wireless communication device ST2 to that of the printer PRT. This application enables the wireless communication device ST2 to perform the printing with the printer PRT via the wireless relay device 13.

In this embodiment, the communication channel management apparatus 10 manages two communication channels, however, it may be applicable to manage additional communication channels. It may be also applicable to construct the control unit 11, the wireless relay device 12 and the wireless relay device 13 independently connecting together via communication lines such as a network and a USB regardless of the integrated configuration in this embodiment.

A2. General Construction of Control Unit:

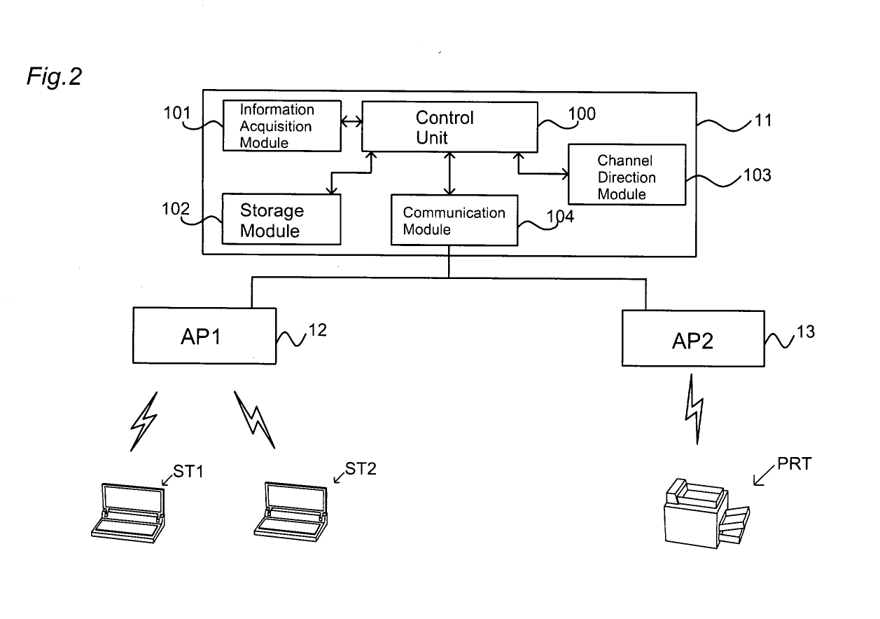

FIG. 2 schematically illustrates the structure of the control unit 11 in an embodiment of the present invention. The control unit 11 is constructed as a microcomputer including a CPU, RAM and ROM. The control unit 11 has a control module 100, an information acquisition module 101, a storage module 102, a channel direction module 103 and a communication module 104. The respective functional blocks are attained by software as the functions of the control unit 11, although the functional blocks may alternatively be actualized by hardware.

The communication module 104 has the function of providing and receiving information between the wireless relay device 12 and the wireless relay device 13. The communication module 104, for example, receives the information regarding the other end of the wireless communication device ST1 to communicate with, and transmits the setting information of the communication channel to the wireless communication device ST1 via the wireless relay device 12. As one example of the information about a receiving the device, the IP address of the printer PRT is available. The information acquisition module 101 acquires the information received by the communication module 104 via the control module 100. The storage module 102 prestores the information used for the judgment as to which communication channels, managed by the communication channel management apparatus, should be assigned to respective wireless communication devices, and the information of the communication channels to be used. In this embodiment, the channel 7 is used for printing and the channel 4 for others. To actualize such allocation, the storage module 102 stores the information by corresponding “receiver IP address=printer PRT” to “communication channel=7CH”, and otherwise to “communication channel=4CH”.

The channel direction module 103 judges as to which communication channel should be used for the wireless communication device ST2 in reference to the storage module 102 based on the information received by the information acquisition module 101. The channel direction module 103 then transmits the instruction of the setting of the communication channel to the wireless relay device 12 via the communication module 104.

A3. General Construction of Wireless Relay Device:

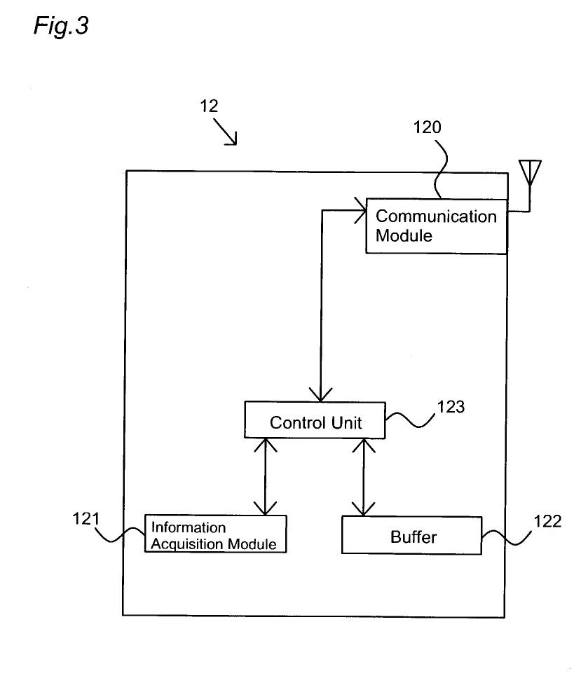

FIG. 3 schematically illustrates the structure of the wireless relay device 12 in this embodiment. The wireless relay device 12 includes a communication module 120, an information acquisition module 121, a buffer 122 and a control module 123. The respective functional blocks are attained by software as the functions of the wireless relay device 12, and controlled by the control module 123 although the functional blocks may alternatively be actualized by hardware.

The communication module 120 receives the information transmitted by the wireless communication device ST2 and others, and transmits the information to the buffer 122 via the control module 123. The received information is once stored into the buffer 122, and then transmitted to the receiving device when the control module 123 regards the volume of data file in the buffer 122 as a certain level. The information acquisition module 121 fetches out the information for specifying the receiving device based on the information stored into the buffer 122, and outputs the information to the control unit 11 via the communication module 120.

The buffer 122 stores the setting instruction of the communication channel for the wireless communication device ST2 and others which the communication module 120 receives from the control unit 11. The control module 123 transfers the setting instruction stored into the buffer 122 to the wireless communication device ST2 via the communication module 120.

In this embodiment, the wireless relay device 13 functions similarly to the wireless relay device 12.

A4. Communication Channel Setting Instruction:

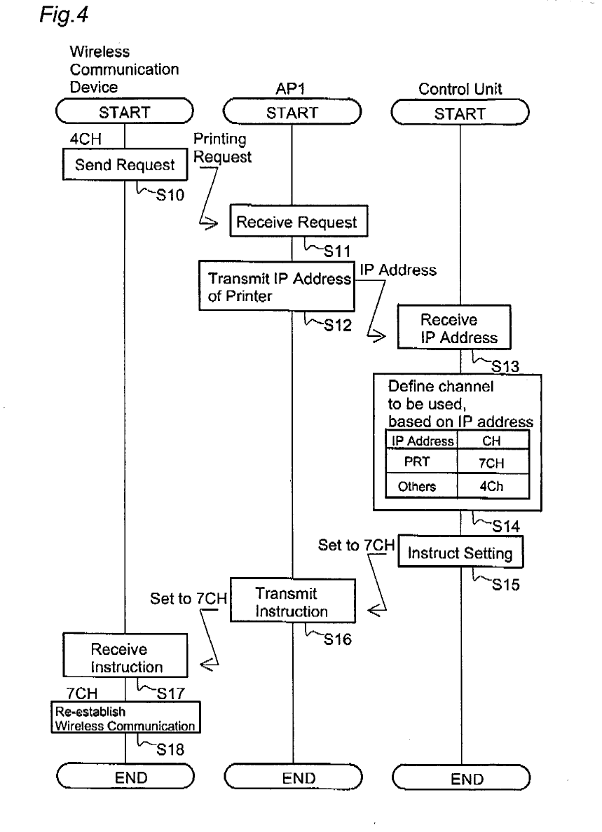

FIG. 4 is a flowchart showing communication channel assigning processing in this embodiment. In the course of this processing, the communication channel management apparatus instructs the wireless communication devices that transmit the request for printing to set the dedicated communication channel for the printing job. In FIG. 4, the processing performed by the wireless communication device ST2, the wireless relay device 12 and the control unit 11 are shown on the left side, the center and the right side, respectively.

First, the wireless communication device ST2 transmits the printing request to the printer PRT via the wireless relay device 12 (Step S10). In the course of this process, “4CH” is set as a communication channel. The wireless relay device 12 fetches out the IP address of the printer PRT from the received printing request as the information for specifying the receiving device (Step S11). The wireless relay device 12 then outputs the fetched IP address of the printer PRT to the control unit 11 (Step S12). The control unit 11 receives the IP address of the printer PRT (Step S13).

The channel direction module 13 in the control unit 11 decides to use “7CH” as a communication channel based on the communication channel assigning conditions stored into the storage module 102 and IP address of the printer PRT (Step S14), and instructs the wireless communication device ST2 to set the communication channel via the wireless relay device 12 (Step S15). When the wireless communication device ST2 requests any request other than the printing, such as the file transfer to the wireless communication device ST1, the fetched IP address indicating the receiving device is different from that of the printer PRT. Accordingly, the channel 4 is assigned as a communication channel corresponding to the conditions shown in the figure. At Step S15, the communication channel management apparatus 10 instructs the wireless communication device ST2 to set the channel 4 as a communication channel. If the communication channel to be newly set is identical to the current channel in use like the above case, the instruction for changing the setting (Step S15) may be skipped.

The buffer 122 in the wireless relay device 12 receives the setting instruction of the communication channel for the wireless communication device ST2 from the control unit 11, and transfers it to the wireless communication device ST2 (Step S16). The wireless communication device ST2 inputs the setting instruction of the communication channel transferred by the wireless relay device 12 (Step S17), and re-establishes the wireless communication (Step S18).

Upon completing the above processing, the communication status of the wireless LAN (WL2a) is actualized as shown in FIG. 1. The wireless communication device ST2 is thus capable of performing the wireless communication by the use of “7CH” as a communication channel, and performing the printing with the printer PRT via the wireless relay device 13, which relays “7CH”.

According to the communication channel management apparatus 10 of the first embodiment as described, it may be applicable to allot the communication channels depending on the job; the printing or others. In general, the size of printing data is relatively large in many cases. The above application thus enables smooth printing processing with the use of the dedicated communication channel for transmitting printing data, thereby preventing other communication from being influenced.

At Step S14, the assigning conditions are not restricted to the cases as discussed, but may be any acquirable information for the information acquisition module 101 in the wireless relay device 12 in response to the request for transmission from the wireless communication device ST2. For example, file type may be available as assigning conditions, which may be recognized by the extension such as “txt” and “jpg”, or by the communication protocols such as “HTTP” and “FTP”.

B. Second Embodiment:

B1. Communication Channel Setting Instruction:

In the second embodiment, the setting instruction of the communication channel is performed based on the speed of the communication. The processing in the wireless communication device ST2 and the wireless relay device 12 is similar to that of the first embodiment although the wireless relay device 12 outputs the communication traffic information of the wireless relay device 12 instead of IP address, and the control unit 11 thus determines the speed of the communication based on the communication traffic information. For example, communication status of the communication channel and information in the process of acquisition are included in the communication traffic information. The communication status may be indicated by parameters as to how many times packet transmission is retried, and the information in the process of acquisition may be indicated by the number of the transmitted packets.

In the second embodiment, the functions of the storage module 102 are different from those of the first embodiment. In the second embodiment, the channel 4 is regarded as a default channel for the communication, and the channel 7 as a spare channel in the case of low speed of the communication. The storage module 102 stores the standard speed of the communication (hereinafter referred to as “threshold value”) for judging as to whether or not the spare channel should be used. For example, the channel 7 is used when the speed of the communication declines to or less than the threshold value. The storage module 102 stores at least the threshold value used for judging assignment and assignment conditions of the communication channels.

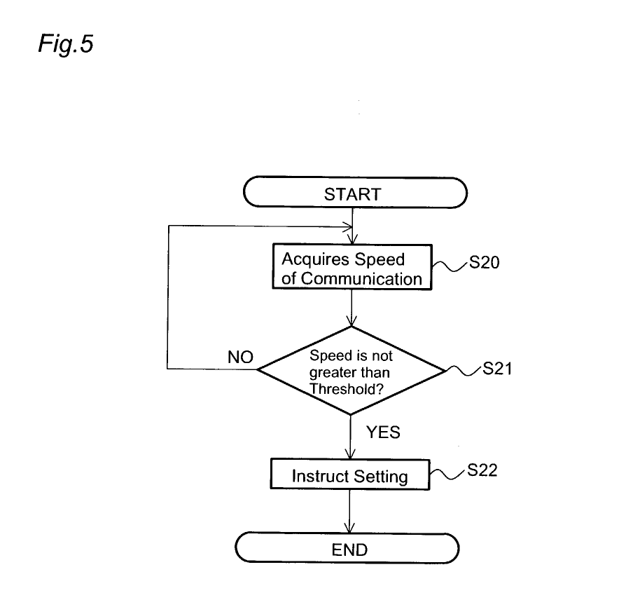

FIG. 5 is a flowchart showing communication channel switchover processing in the second embodiment. The wireless relay device 12 outputs the communication traffic information to the control unit 11 at the prescribed intervals. The information acquisition module 101 in the control unit 11 acquires the speed of the communication measured by the control module 100 based on the communication traffic information that is transmitted from the output module 121 (Step S20).

The channel direction module 103 judges as to whether or not the acquired speed of the communication is not greater than the threshold value (Step S21). In the case of not greater than the threshold value, the channel direction module 103 instructs to set the communication channel based on the assigning conditions (Step S21). Otherwise, the processing is repeated from Step S20.

The channel direction module 103 instructs all wireless communication devices, which share the communication channel and may cause the trouble of low speed of the communication, to change respective settings of the communication channel.

According to the communication channel management apparatus 10 as described, it may be applicable to switchover the communication channel that is shared by plural wireless communication devices to the different channel, thereby preventing the decline of the speed of the communication.

At Step S21, assigning conditions are not restricted to the above information but may be any acquirable information for the wireless relay device 12. For example, the settings for the communication channel may be performed based on the judgment as to whether or not the volume of data is over the threshold value. As another example, it may be applicable to perform the settings based on the judgment whether or not the number of the wireless communication devices sharing the communication channel is over the threshold value.

C. Modifications:

The above embodiments and their modifications are to be considered in all aspects as illustrative and not restrictive. There may be many modifications, changes, and alterations without departing from the scope or spirit of the main characteristics of the present invention.

C1. First Modification:

In the embodiments as discussed, the communication channels to be set are fixed corresponding to judging factors for assigning the communication channel, however, it may be also applicable to perform the search and the settings in response to the request for assignment. In one example of this application, the communication channel may be set by searching the communication channel of the receiving device where judging factor is the IP address of the receiving device. In another example, the communication channel may be set by searching the communication channel whose speed of the communication is over the prescribed value, thereby preventing the communication channel to be newly assigned from being congested.

In the first modification, the search for assigning the communication channel may be performed based on the prescribed search orders, which are stored in the storage module or may be in any order.

C2. Second Modification:

In the embodiments as discussed, the communication channel is assigned to the transmitting wireless communication device, however, it may be also applicable to assign to the receiving wireless communication device instead. For example, it may be applicable to assign “1CH” to the wireless communication device using “11CH” where the wireless communication device using “1CH” transfers file to the wireless communication device using “11CH”. This application enables the communication on the suitable channel even when setting the communication channel more than once.

C3. Third Modification:

In the embodiments of the present invention, the technique of the assignment is focused on assigning the communication channel, however, it may be also applicable to assign ESS-ID as well. This application thus enables not only the switchover of the communication channel but the wireless communication joining other groups.

C4. Fourth Modification:

In the embodiments of the present invention, the case of applying this invention to the wireless communication devices based on the International Standard IEEE802.11 are discussed, however, other standards are applicable as well. The scope and spirit of the present invention are indicated by the appended claims, rather than by the foregoing description.

What is claimed is:

1. A communication channel management apparatus that manages plural communication channels used for wireless communication between wireless communication devices comprising:
a storage module that prestores an assigning condition for assigning one of the plural communication channels to be managed;
an information acquisition module that acquires predetermined information used for judging the assigning conditions from either the wireless communication devices in the wireless communication; and
a channel direction module that instructs the communication channel appropriate for the wireless communication device based on the acquired information and the assigning conditions.

2. A communication channel management apparatus in accordance with claim 1, wherein the assigning condition is set based on the speed of the communication in the wireless communication.

3. A communication channel management apparatus in accordance with claim 1, wherein the assigning condition is set based on a protocol applied in the wireless communication.

4. A communication channel management apparatus in accordance with claim 1, wherein the assigning conditions are set based on the volume of data file transferred with the wireless communication.

5. A communication channel management apparatus in accordance with claim 1, wherein the assigning conditions are set based on file type transferred with the wireless communication.

6. A communication channel management apparatus in accordance with claim 1, wherein the assigning conditions are set based on the number of the wireless communication devices that use a communication channel.

7. A communication channel management apparatus in accordance with claim 1, wherein the storage module prestores the communication channel to be assigned corresponding to the assigning conditions, and
the channel direction module sets the communication channel to be used based on the stored information in the storage module.

8. A communication channel management apparatus in accordance with claim 1, wherein the channel direction module searches the communication channel that satisfies the assigning conditions, and instructs the wireless communication device to use the searched communication channel.

9. A communication channel management apparatus in accordance with claim 1, wherein the channel direction module further instructs to assign identification information in order to specify a group of the wireless communication.

10. A communication channel management apparatus in accordance with claim 1, wherein the information acquisition module fetches out the predetermined information from a relay device that relays the wireless communication on each communication channel.

11. A communication channel management apparatus in accordance with claim 1, wherein the channel direction module instructs to switch over the current communication channel used by the wireless communication device to a different channel.

12. A wireless relay device that relays wireless communication between wireless communication devices on a predetermined communication channel comprising:
an information acquisition module that acquires predetermined information that is used by a communication channel management apparatus corresponding to the wireless relay device for assigning one of the plural communication channels to be managed;
an information output module that outputs the predetermined information to the communication channel management apparatus; and
a direction transfer module that inputs an instruction as to which channel should be used for the wireless communication, and transfers the instruction to the corresponding wireless communication device.

13. A method for controlling an assignment of a communication channel in a communication channel management apparatus that manages plural communication channels used for wireless communication between wireless communication devices, the method comprising the steps of:
(a) prestoring assigning conditions for assigning one of the plural communication channels to be managed;
(b) acquiring the predetermined information used for judging the assigning conditions from either the wireless communication devices in the wireless communication; and
(c) instructing the communication channel appropriate for the wireless communication device based on the acquired information and the assigning conditions.

14. A method for controlling a wireless relay device that relays wireless communication between wireless communication devices on a predetermined communication channel, the method comprising the steps of:
(a) acquiring the predetermined information used by a communication channel management apparatus corresponding to the wireless relay device for assigning one of the plural communication channels to be managed;
(b) outputting the predetermined information to the communication channel management apparatus; and
(c) inputting an instruction as to which channel should be used for the wireless communication, and transferring the instruction to the corresponding wireless communication device.

15. A computer readable recording medium in which a computer program that is used to assign a communication channel in a communication channel management apparatus that manages plural communication channels used for wireless communication between wireless communication devices, the computer program causing the communication channel management apparatus to attain the functions of:
prestoring an assigning conditios for assigning plural communication channels to be managed;
acquiring the predetermined information used for judging the assigning conditions from either the wireless communication devices in the wireless communication; and
instructing the communication channel appropriate for the wireless communication device based on the acquired information and the assigning conditions.

16. A computer readable recording medium in which a computer program that is used for a wireless relay device that relays wireless communication between wireless communication devices on a predetermined communication channel, the computer program causing wireless relay device to attain the functions of:
acquiring predetermined information used by the communication channel management apparatus corresponding to the wireless relay device for assigning one of the plural communication channels to be managed;
outputting the predetermined information to the communication channel management apparatus; and
inputting an instruction as to which channel should be used for the wireless communication, and transferring the instruction to the corresponding wireless communication device.
